(19) United States
(12) Patent Application Publication
(10) Pub. No.: US 2013/0068530 A1
(43) Pub. Date: Mar. 21, 2013

(54) SYSTEM AND METHOD OF CLARIFYING DRILLING MUD AND A HYDROPHILIC LIQUID OR SOLUTION FOR USE IN CLARIFYING DRILLING MUD

(71) Applicant: Jurgen D. Scheide, Summit, NJ (US)

(72) Inventor: Jurgen D. Scheide, Summit, NJ (US)

(21) Appl. No.: 13/624,094

(22) Filed: Sep. 21, 2012

Related U.S. Application Data
(60) Provisional application No. 61/537,246, filed on Sep. 21, 2011.

(51) Int. Cl. E21B 21/06; B04B 5/10; B01D 21/26; C09K 8/02; C09K 3/00; B01D 21/01

(52) U.S. Cl. 175/66; 252/60; 210/702; 210/738; 210/737; 210/205; 210/201; 210/195.1; 210/178

(57) ABSTRACT

Processes and systems are provided with a hydrophilic liquid or solution for clarifying drilling mud to separate diesel oil or other oil lubricants out from the drilling mud such that the diesel oil or other oil lubricants may be recycled to a well for reuse as a lubricant for drilling components, such as a drilling bit. The hydrophilic liquid or solution may be recovered and reused/recycled in the processes and/or systems as well.

### CROSS-REFERENCE TO RELATED APPLICATION(S)

This application is a non-provisional patent application that claims the benefit of the filing date of, and priority to, U.S. Provisional Application No. 61/537,246, filed Sep. 21, 2011, the entirety of which is incorporated herein by reference.

### BACKGROUND OF THE INVENTION

In the oil and gas exploration industry, drilling is the method of reaching the layers of fossil fuel, either on-shore or off-shore. One of the important parts of the drilling equipment is the rig, which consists of the extendible drilling shaft and the drilling bit. The drilling bit only works efficiently if lubricated.

When dealing with lubricating the drilling bit to make the drilling process more efficient, lubrication liquids can be either water-based or oil-based. A preferred method of lubrication is the use of oil based lubricants, both for on shore and off shore drilling. During oil based drilling, diesel oil or other similar organic hydrocarbons or even triglycerides typically are being used. The lubricant is being pumped downward into the hollow drilling shaft and sprayed onto the rotating drilling bit, thus providing cooling and lubrication. Depending on the geological structure of the place of drilling, ground minerals and other fine drilling debris of the tectonic layers are being mixed and suspended with the lubricant and therewith producing the drilling mud. This mud is being pushed upward to the surface on the outside of the drilling shaft. For environmental and economic reasons, the drilling mud is being collected and clarified from major sediments, which in the oil industry are known as cuttings. These drill cuttings contain coarse particles of rock, sand and other minerals as well as very fine particles down to the size of about 5 microns. In order to reuse the oil based lubricant, the oil based lubricant and/or the mud having the oil based lubricant therein has to be processed to remove or reduce the sediments from the mud. A traditional method in the oil industry uses a three stage clarification process as follows:
a) In the first stage, the recovered oil-based mud is pumped onto vibrating sifters to remove all coarse particles.
b) The out-flowing oil mud then is exposed to separation based on differences of specific weight. This is accomplished by liquid-solid separation centrifuges, which in the industry are known as “Decanters”. Separation takes place in two stages:
   b1) At gravitational forces created by between 1,000 to 2,000 rpm (rounds per minute), and
   b2) At gravitational forces created by between 2,000 to 3,000 rpm.

The resulting oil mud after stage b2) is being recycled to the drilling bit as described above. A common system for employing the above process is shown in FIG. 1. As shown in FIG. 1, drilling mud may flow from a well (visually depicted by arrow 1, e.g., via a path, pipe, channel, etc.) into one or more vibrating sifters 2 such that the cuttings collection having the larger debris therein may be discharged (visually depicted by arrow 4, e.g., via a path, pipe, channel, etc.). The flow from the well may be at a temperature of 120° F.-140° F., and may be flowing at a rate of 200-250 gpm or gallons per minute. The remaining drilling mud may be passed from the one or more vibrating sifters 2 into a first decanter 6 (e.g., VFD1-Decanter-1 as discussed herein) by a connection 8 therebetween. The first decanter 6 may be used to remove heavier solids, such as, but not limited to the recovery of barite as discussed in view of Table 1 below. These heavier solids may be discharged from the first decanter 6 out of exit 10 such that the remaining portion of the drilling mud in the first decanter 6 defines a first effluent comprising: (i) solid materials or fines that are smaller than the heavier solids previously removed; and (ii) the oil lubricant, such as, but not limited to diesel oil. The first effluent may be passed from the first decanter 6 into a second decanter 14 (e.g., VFD2-Decanter-2 as discussed herein) through connection 12 therebetween. Any solids that are separated from the effluent may be discharged via exit 16 of the second decanter 14, and the remaining effluent (which may define a second effluent) is typically recycled and sent back to the well (as indicated and visually depicted by arrow 18, e.g., via a path, pipe, channel, etc.) to lubricate the drilling bit. However, as further discussed below, the use of the second decanter 14 (e.g., high speed Decanter-2) does not accomplish its purpose of clarifying the oil lubricant from the remaining solids and fines of the effluent after the first decanting step, e.g., the barite recovery step.

The oil drilling industry faces substantial technical and economical problems with the aforementioned recovery process. Repeated clarification as described results in ever increasing concentration of fine sediment material (e.g., “low gravity solids”, “low gravity fines”, etc.) with a size of about 5 microns, which, so far, cannot be removed from the oil lubricants. The ever increasing concentration of fine solids can lead to disastrous results. For example, the out-flowing oil mud may become so heavy and viscous (e.g., after the aforementioned effluent is recycled one or more times) that the drilling shaft gets stuck and can no longer be rotated or moved. In many cases, the entire shaft and the very valuable drilling bit cannot be removed and are, consequently, entirely lost. In other cases, it takes incredible efforts to finally recover the drilling shaft and the drilling bit. Therefore, substantial time and/or money are lost. In addition, very often a complete new hole has to be drilled to reach the fuel bearing layers underground, especially where the entire shaft and/or the drilling bit are stuck underground and, therefore, must be abandoned.

Another problem of the oil drilling industry is the fact that increasing high formation pressures are building the deeper the hole, which could cause blowouts. To suppress high formation pressures and to avoid blowouts, barite is used as a weighting agent for drilling fluids. As the hole is drilled the bit passes through various formations, each with different characteristics. The deeper the hole the more barite is needed as a percentage of total lubricant mix. This use of barite increases the amount of solids in the drilling mud even more and adds to the problems with heavy and viscous oil mud as described above.

Table 1 provides technical data of the described conventional process:

TABLE 1
Typical analytical data of Drilling Oil Mud - 100% Diesel

| | | |
|---|---|---|
| A) | 1. Flow out temperature from well ° F. | 120-140 |
| | 2. Mud weight from well (pound per gallon) ppg | 15.8-15.9 |
| | 3. Mud density (grams per cubic centimeter) g/ccm | 1.892-1.905 |
| | 4. Solids content % by volume | 36 |
| | 5. Oil content % by volume | 60 |
| | 6. Water content % by volume | 4 |
| B) | Barite recovery (Effluent 1/Drilling Oil Mud 1) | |
| | 1. Flow in temperature Decanter-1 ° F. | 110-120 |
| | 2. Flow out temperature Decanter-1 ° F. | 100-110 |
| | 3. Mud weight in ppg | 15.8-15.9 |
| | 4. Mud density in (grams per cubic centimeter) g/ccm | 1.892-1.905 |
| | 5. Mud weight out ppg | 10.5 |
| | 6. Mud out density g/ccm | 1.198 |
| | 7. Solids content % by volume | 31 |
| | 8. Oil content % by volume | 65 |
| C) | High Speed Effluent 2/Drilling Oil Mud 2 | |
| | 1. Flow in temperature Decanter-2 ° F. | 100-110 |
| | 2. Flow out temperature Decanter-2 ° F. | 90-100 |
| | 3. Mud weight in ppg | 10.5 |
| | 4. Mud density in g/ccm | 1.198 |
| | 5. Mud weight out ppg | 9.5 |
| | 6. Mud density out g/ccm | 1.138 |
| | 7. Solids content % by volume | 31 |
| | 8. Oil content % by volume | 67 |
| | 9. Water content % by volume | 2 |

As Table 1 clearly shows only the use of Decanter-1, the barite recovery, is an efficient step. The mud weight is being reduced from 15.8-15.9 ppg (and the mud density from 1.892-1.905 g/ccm respectively) to a mud weight of 10.5 ppg (and to a mud density of 1.198 g/ccm). The solids content is being reduced from 36% to 31% by volume. However, the use of the high speed Decanter-2 does not accomplish its purpose of clarifying the diesel oil lubricant from the remaining solids and fines of the effluent after the barite recovery step. Mud weight is only reduced from 10.5 to 9.5 ppg (specific density from 1.198 to 1.138 g/ccm). Too much solid materials remain in the diesel oil lubricant and, consequently, are being recycled to the well along with the diesel oil lubricant, which is an undesirable result (and can lead to the aforementioned problem related to the heavy and viscous oil mud). Additionally or alternatively, spectrum size of the solids may be depicted via one or more graphs.

It would therefore be desirable to provide an improved process for clarification of the oil mud, and one or more systems for employing that process, such that the undesirable materials, such as the solid materials in the mud, are removed from the oil lubricant before recycling the oil lubricant to the well.

### SUMMARY OF THE INVENTION

It is the purpose of this invention to improve the clarification of oil mud to such an extent that recovery of diesel oil and/or other suitable oil lubricants is improved and/or optimized. The better the recovery, the more often such oil lubricants can be recycled. Achieving more efficient use of such oil lubricants, such as by increasing the number of times such oil lubricants may be recycled, saves substantial expenses related to the introduction and use of fresh lubricant oil. In addition, it becomes less likely that one or more entire drilling bits and/or one or more drilling shafts are lost, which results in decreasing drilling time to reach the fossil fuel; and saving expenses related to: (i) recovering such one or more drilling bits and/or one or more drilling shafts; (ii) abandoning unrecoverable drilling bit(s) and/or drilling shaft(s) and attaching new drilling bit(s) and/or drilling shaft(s); and (iii) drilling new holes for one or more new drilling bits and/or one or more shafts in the event that prior holes may not be cleared.

Surprisingly it has been found that separation of diesel oil or other oil lubricants can be dramatically enhanced when a hydrophilic liquid is introduced into the clarification process and/or employed as part of one or more systems being used to achieve clarification. Hydrophilic liquids may include one or more of the following: Water, Glycerin, Propylene Glycol (1,2-Propanediol) and other water soluble Glycols and Polyols such as Ethylene Glycol, Xylitol, Sorbitol, Glucose Syrup, Fructose Syrup, polymerized Polyols, etc., as well as solutions of these chemicals in water. It has been found that combinations of water, glycerin, propylene glycol and/or one or more polyol syrups are very efficient for separation (e.g., because they may be used to provide or reach a higher specific weight).

The present invention of the instant application allows for the improved clarification of diesel oil that operates as a lubricant or other oil lubricants from drilling mud such that the recovered diesel oil or other oil lubricants may be recycled to the well and used again for lubrication of the drilling machinery, such as the drilling bit.

In accordance with at least one aspect of the present invention, at least one embodiment of a process for clarifying drilling mud and recovering one or more oil lubricants for recycling to a well to lubricate one or more drilling components, may include: mixing a hydrophilic liquid or solution with an effluent including an oil lubricant and one or more solid and/or fine materials having a predetermined size such that the one or more solid and/or fine materials having the predetermined size bind to the hydrophilic liquid or solution, thereby being hydrophilic and separating from, and clarifying, the one or more oil lubricants in the effluent; and recovering the separated, clarified one or more oil lubricants. One or more embodiments of the process may further include at least one of: (i) recycling the clarified one or more oil lubricants to the well such that the clarified one or more oil lubricants lubricate the one or more drilling components located in the well; (ii) discharging any of the one or more separated solid and/or fine materials; and (iii) recovering the hydrophilic liquid or solution. At least one process of the invention may further include repeating the mixing and recovering of the separated, clarified one or more oil lubricants steps with the recovered hydrophilic liquid or solution. At least one process of the invention may further include at least one of: (i) heating the hydrophilic liquid or solution to about 140° F. before the mixing step; (ii) mixing and heating a homogeneous mix defining the hydrophilic liquid or solution in a jacketed and/or insulated mixing tank, thereby increasing the speed to reach the homogeneous mix and the hydrophilic liquid or solution; and (iii) applying one or more elevated temperatures such that a difference in a specific weight of the hydrophilic solution or liquid and a specific weight of the oil lubricant is created; and a difference in surface tension around any given particle of the one or more solid and/or fine materials is reached, thereby promoting separation of the oil lubricant from the one or more solid and/or fine materials.

The mixture may be supplied to one or more centrifuges or tricanters that operate to at least one of: (i) perform the recycling, discharging and recovering of the hydrophilic liquid or solution steps; (ii) separate the mixture at about 2,000 to about 3,000 rotations per minute; and (iii) discharge the hydrophilic liquid or solution under pressure via an adjustment of a centripetal pump such that the oil lubricant discharges cleanly by gravity flow for the recycling thereof.

The one or more oil lubricants may be hydrophobic, thereby promoting or facilitating the separation from at least one of the one or more hydrophilic solid and/or fine materials and the hydrophilic liquid or solution. Additionally or alternatively, the process may involve at least one of the following: (i) the one or more solid and/or fine materials include at least one of fibrous materials or solids, crystalline materials or solids, low gravity solids and low gravity fines; (ii) the mixing occurs in a mixing tank; (iii) the mixing step further comprises creating a mixture of the oil mud or the effluent and the hydrophilic liquid or solution comprising about 25 percent of the hydrophilic liquid and about 75 percent of the oil mud or the effluent; (iv) the mixing step further comprises creating a mixture of the oil mud or the effluent and the hydrophilic liquid or solution comprising about 30 percent of the hydrophilic liquid and about 70 percent of the oil mud or the effluent; (v) the mixing step further comprises creating a mixture of the oil mud or the effluent and the hydrophilic liquid or solution comprising about 25 percent to about 30 percent of the hydrophilic liquid and about 70 percent to about 75 percent of the oil mud or the effluent; (vi) the effluent is created by either a first decanter that operates to receive the drilling mud from the well and to remove one or more solid and/or fine materials, which are heavier than, or are larger than the predetermined size of, the one or more solid and/or fine materials having the predetermined size, and/or barite or a second decanter that receives an effluent from the first decanter and operates to remove additional one or more solid and/or fine materials, which are heavier than, or are larger than the predetermined size of, the one or more solid and/or fine materials having the predetermined size, and/or barite; (vii) the hydrophilic liquid or solution is supplied to the effluent of the first decanter, thereby eliminating the need to use the second decanter; (viii) the first decanter operates to receive the drilling mud indirectly from the well through one or more vibrating sifters; (ix) the drilling mud flows from the well at a temperature of about 120° F.-about 140° F. and/or at a rate of about 200-about 250 gallons per minute; (x) the one or more vibrating sifters operate to receive the drilling mud from the well and to remove debris from the drilling mud that is larger or heavier than the one or more solid and/or fine materials having the predetermined size; (xi) the drilling mud is mixed with the hydrophilic liquid or solution at one or more temperatures of up to 60° C. and is exposed to high gravitational forces; and (xii) the predetermined size is about 5 microns.

In accordance with at least an additional aspect of the present invention, a system for clarifying drilling mud and recovering one or more oil lubricants for recycling to a well to lubricate one or more drilling components, may include: a mixing tank that operates to: (i) receive a hydrophilic liquid or solution and an effluent including an oil lubricant and one or more solid and/or fine materials having a predetermined size therein; and (ii) mix the hydrophilic liquid or solution with the one or more solid and/or fine materials having the predetermined size such that the hydrophilic liquid or solution binds to the one or more solid and/or fine materials and the one or more bound solid and/or fine materials are hydrophilic; and one or more centrifuges that operate to: (i) receive, from the mixing tank, the combination of the hydrophilic liquid or solution and effluent including the oil lubricant and the one or more solid or fine materials having the predetermined size; (ii) separate the hydrophilic liquid or solution, the one or more hydrophilic solid and/or fine materials and the oil lubricant from each other; and (iii) recycle the separated or clarified oil lubricant to the well for reuse as a lubricant for the one or more drilling components.

The system may involve or include at least one of the following: (i) the one or more centrifuges include at least one of: a clarifying liquid to liquid disc centrifuge with one or more adjustable solids discharge mechanisms, one or more semi-continuous centrifuges, one or more continuous centrifuges, and a three stage decanter or tricanter; (ii) the predetermined size is about 5 microns; (iii) the mixing tank operates to create a mixture of the oil mud or the effluent and the hydrophilic liquid or solution, the mixture comprising at least one of: about 25 percent of the hydrophilic liquid and about 75 percent of the oil mud or the effluent, about 30 percent of the hydrophilic liquid and about 70 percent of the oil mud or the effluent, and about 25 percent to about 30 percent of the hydrophilic liquid and about 70 percent to about 75 percent of the oil mud or the effluent; and (iv) the one or more centrifuges further operate to at least one of: recover the hydrophilic liquid or solution and recycle the recovered hydrophilic liquid or solution to the mixing tank for reuse; discharge any separated solid and/or fine materials; separate the mixture at at least one of: about 3,000 rotations per minute; about 2,000 to about 3,500 rotations per minute; about 3,500 rotations per minute; and discharge the hydrophilic liquid or solution under pressure via an adjustment of a centripetal pump connected to the one or more centrifuges such that the oil lubricant discharges cleanly by gravity flow for the recycling thereof.

One or more embodiments of the system may further include one or more decanters that operate to separate drilling mud into the effluent and one or more solid and/or fine materials that are heavier than, or larger than the predetermined size of, the one or more solid and/or fine materials of the effluent, wherein the mixing tank further operates to receive the effluent from the one or more decanters before mixing the effluent with the hydrophilic liquid or solution. Additionally or alternatively, (i) the one or more decanters may include a first decanter and a second decanter, and the effluent may be created by either the first decanter that operates to receive the drilling mud from the well and to remove one or more solid and/or fine materials, which are heavier than, or are larger than the predetermined size of, the one or more solid and/or fine materials having the predetermined size, and/or barite, or may be created by the second decanter that receives an effluent from the first decanter and operates to remove additional one or more solid and/or fine materials, which are heavier than, or are larger than the predetermined size of, the one or more solid and/or fine materials having the predetermined size, and/or barite; and/or the one or more decanters may include only a first decanter, wherein the hydrophilic liquid or solution may be supplied to the effluent of the first decanter, thereby eliminating the need to use a second decanter.

One or more vibrating sifters may be included in a system of the invention where the one or more vibrating sifters may operate to receive the drilling mud from the well, to remove at least a portion of debris from the drilling mud that is larger or heavier than the one or more solid and/or fine materials having the predetermined size and to pass the remaining drilling mud into the one or more decanters. The one or more vibrating sifters may be included in one or more embodiments of the system where only one decanter is used and/or where the first and the second decanters are used as described above.

A means for controlling a flow of the drilling mud from the well may be included in the one or more embodiments of the system such that the means for controlling the flow controls the flow of the drilling mud at a temperature of about 120° F.-about 140° F. and/or at a rate of about 200-about 250 gallons per minute.

One or more embodiments of the system may include at least one of: (i) a heat exchanger or a means for heating the hydrophilic liquid or solution to about 140° F. before the hydrophilic liquid or solution is introduced into the mix tank; and (ii) a jacketed and/or insulated mixing tank that operates to heat a homogeneous mix defining the hydrophilic liquid or solution, thereby increasing the speed to reach the homogeneous mix and the hydrophilic liquid or solution.

In accordance with at least a further aspect of the present invention, a hydrophilic liquid or solution may be used for separating, or improving the separation of, drilling mud from one or more oil lubricants. The hydrophilic liquid or solution may include a homogeneous mix of one or more of the following: Water, Glycerin, Propylene Glycol (1,2-Propanediol) and other water soluble Glycols and Polyols comprising at least one of Ethylene Glycol, Xylitol, Sorbitol, Glucose Syrup, Fructose Syrup, polymerized Polyols, and one or more solutions of Glycerin, Propylene Glycol (1,2-Propanediol), water soluble Glycols, water soluble Polyols, Ethylene Glycol, Xylitol, Sorbitol, Glucose Syrup, Fructose Syrup, and polymerized Polyols in water. The hydrophilic liquid or solution may further include at least one of the following mixture combinations: (i) about 20 percent glycerin and about 80 percent water; (ii) about 55 percent water, about 10 percent glycerin and about 35 percent propylene glycol; (iii) about 30 percent water and about 70 percent propylene glycol; (iv) about 70 percent water and about 30 percent ethylene glycol; (v) about 40 percent water, about 25 percent glycerin and about 35 percent propylene glycol; (vi) about 35 percent water, about 30 percent propylene glycol and about 35 percent glycerin; (vii) about 19.8 percent water, about 38.8 percent propylene glycol and about 41.4 percent glycerin; (viii) about 46 percent propylene glycol and 54 percent glycerin; (ix) about 15 percent water, about 35 percent propylene glycol and about 50 percent high fructose corn syrup (76° Brix); and about 12 percent water, about 28 percent propylene glycol and about 60 percent high fructose corn syrup (76° Brix). Additionally or alternatively, the hydrophilic liquid or solution may further include at least one of the following mixture combinations: (i) about 20 percent glycerin and about 80 percent water and having a specific density, at about at about 20° C., of about 1.047 g/ccm; (ii) about 55 percent water, about 10 percent glycerin and about 35 percent propylene glycol and having a specific density, at about at about 20° C., of about 1.046 g/ccm; (iii) about 30 percent water and about 70 percent propylene glycol and having a specific density, at about at about 20° C., of about 1.042 g/ccm; (iv) about 70 percent water and about 30 percent ethylene glycol and having a specific density, at about at about 20° C., of about 1.050 g/ccm; (v) about 40 percent water, about 25 percent glycerin and about 35 percent propylene glycol and having a specific density, at about at about 20° C., of about 1.086 g/ccm; (vi) about 35 percent water, about 30 percent propylene glycol and about 35 percent glycerin and having a specific density, at about at about 20° C., of about 1.104 g/ccm; (vii) about 19.8 percent water, about 38.8 percent propylene glycol and about 41.4 percent glycerin and having a specific density, at about at about 20° C., of about 1.141 g/ccm; (viii) about 46 percent propylene glycol and 54 percent glycerin and having a specific density, at about at about 20° C., of about 1.150 g/ccm; (ix) about 15 percent water, about 35 percent propylene glycol and about 50 percent high fructose corn syrup (76° Brix) and having a specific density, at about at about 20° C., of about 1.189 g/ccm; and about 12 percent water, about 28 percent propylene glycol and about 60 percent high fructose corn syrup (76° Brix) and having a specific density, at about at about 20° C., of about 1.226 g/ccm.

The homogeneous mix may be prepared in a jacketed and/or insulated mixing tank that operates to heat the mix, thereby increasing the speed to reach the homogeneous mix. The hydrophilic liquid or solution may have a specific density, at about 20° C., of: at least about 1.0 gram per cubic centimeter (“g/ccm”), about 1.047 g/ccm, about 1.046 g/ccm, about 1.042 g/ccm, about 1.050 g/ccm, about 1.086 g/ccm, about 1.104 g/ccm, about 1.141 g/ccm, about 1.150 g/ccm, about 1.189 g/ccm, about 1.226 g/ccm, about 1.042 g/ccm-about 1.226 g/ccm, greater than about 1.226 g/ccm.

In one or more embodiments of the hydrophilic liquid or solution, the homogeneous mix may include at least a bi-valent molecular structure having at least one hydrophobic group on one side of the molecule and at least one hydrophilic group on the other end of the molecule such that the bi-valent molecular structure is disposed in, or forced in, a border layer between the hydrophilic liquid or solution and a hydrophobic oil lubricant of a drilling mud having the oil lubricant and one or more solid and/or fine materials therein and/or the effluent such that one or more layers of the hydrophobic oil lubricants around the solid and/or fine materials are replaced with one or more layers of the hydrophilic liquid or solution, thereby permitting the separation, or the improved separation, of the oil lubricant from the one or more solid and/or fine materials. The bi-valent molecular structure may include 1,2-propanediol having one hydrophobic methyl (—CH3) group on one side of the molecule and two hydrophilic hydroxyl (—OH) groups on the other end such that any propylene glycol is oriented in, or forced in, a border layer between the hydrophilic liquid or solution and the hydrophobic oil lubricant, thereby removing the oil lubricant from the hydrophilic oriented solid and/or fine materials and forming a continuous oil layer above the hydrophilic liquid or solution.

Other objects of the invention will in part be obvious and will in part be apparent from the following description.

### BRIEF DESCRIPTION OF THE DRAWINGS

For the purposes of illustrating the various aspects of the invention, wherein like numerals indicate like elements, there are shown in the drawings simplified forms that may be employed, it being understood, however, that the invention is not limited by or to the precise arrangements and instrumentalities shown. The drawings may not be to scale, and the aspects of the drawings may not be to scale relative to each other. To assist those of ordinary skill in the relevant art in making and using the subject matter hereof, reference is made to the appended drawings and figures, wherein:

FIG. 1 is a diagram of a prior art example of a system for clarifying drilling mud to recover oil-based lubricants.

FIG. 2 is a diagram of a system for clarifying drilling mud to recover oil-based lubricants in accordance with one or more aspects of the present invention.

### DETAILED DESCRIPTION OF THE PRESENT INVENTION

A system and method of using same is disclosed herein for clarifying drilling mud and recovering one or more oil lubricants for recycling to a well to lubricate one or more drilling components. The method may include the steps of mixing a hydrophilic liquid or solution with an effluent including an oil lubricant and one or more solid or fine materials having a predetermined size such that the one or more solid or fine materials having the predetermined size bind to the hydrophilic liquid or solution, thereby becoming hydrophilic and separating from the one or more oil lubricants in the effluent; and recovering the separated one or more oil lubricants.

The system for clarifying drilling mud and recovering one or more oil lubricants for recycling to a well to lubricate one or more drilling components may include: one or more decanters that operate to separate drilling mud into solid materials and/or fine materials having a predetermined size and an effluent including an oil lubricant and one or more solid or fine materials having a size smaller than the predetermined size; a mixing tank that operates to receive the effluent including the oil lubricant and the one or more solid or fine materials having the size smaller than the predetermined size from the one or more decanters and introduce a hydrophilic liquid or solution thereto, wherein the hydrophilic liquid or solution operates to bind to the one or more solid or fine materials having the size smaller than the predetermined size such that the one or more smaller solid or fine materials become hydrophilic; and one or more centrifuges, such as tricanters, that operate to: (i) receive the combination of the hydrophilic liquid or solution and effluent including the oil lubricant and the one or more solid or fine materials having a size smaller than the predetermined size; and (ii) to separate the hydrophilic liquid or solution, the one or more hydrophilic smaller solid or fine materials and the oil lubricant from each other such that the oil lubricant operates to be recycled to the well and reused as a lubricant for the one or more drilling components (e.g., without the hydrophilic liquid or solution and/or the one or more hydrophilic smaller solid or fine materials).

Surprisingly it has been found that separation of diesel oil or other oil lubricants can be dramatically enhanced when a hydrophilic liquid is introduced into the clarification process and/or employed as part of one or more systems being used to achieve clarification. Hydrophilic liquids may include one or more of the following: Water, Glycerin, Propylene Glycol (1,2-Propanediol) and other water soluble Glycols and Polyols such as Ethylene Glycol, Xylitol, Sorbitol, Glucose Syrup, Fructose Syrup, polymerized Polyols, etc., as well as solutions of these chemicals in water. It has been found that combinations of water, glycerin, propylene glycol and/or one or more polyol syrups are very efficient for separation (e.g., because they may be used to provide or reach a higher specific weight).

Separation is especially successful, if at least one of the ingredients in the inventive solution consists of a bi-valent molecular structure. One example of such bi-valent ingredient is 1,2-propanediol. It contains one hydrophobic methyl (—CH3) group on one side of the molecule and two hydrophilic hydroxyl (—OH) groups on the other end. Thus propylene glycol orients itself in the border layer between the hydrophobic oil of the drilling oil mud and the inventive hydrophilic liquid. As a result, the oil of the drilling oil mud is being removed from the hydrophilic oriented solids in the drilling oil mud and starts to orient itself around the hydrophobic —CH3 groups to form a continuous oil layer above the heavier inventive hydrophilic liquid.

The efficiency is even increased when the hydrophilic solution is adjusted in its specific density. It creates a preferable difference between the density of the hydrophilic liquid and the density of the oil lubricant. Oil-based lubricants all have a density of about 0.90 g per cubic centimeter (g/ccm) at 20 degrees C. or less. It is the subject of this invention to separate drilling oil mud into its oil based lubricant and any sediment of about the size of 5 microns by using hydrophilic chemicals or their solutions in water with specific densities of at least 1 g/ccm (at 20 degrees C.) or higher.

A preferred combination is a solution of both glycerin and 1,2-propanediol in water. Another preferred combination is an aqueous solution of propylene glycol and high fructose corn syrup. Depending on concentration and combination of polyols used in the hydrophilic solution various densities can be adjusted, reaching up to 1.226 g per cubic centimeter. This way various kinds of sediment in oil mud can be dealt with. It also has been found that an even more efficient separation of oil based lubricant from oil mud can be accomplished if elevated temperatures are being applied during the process. Under these conditions not only a difference in specific weight of the hydrophilic solution and specific weight of the oil lubricant is being created, but also a difference in surface tension around any given sediment particle is reached. The layers of hydrophobic lubricants around sediment particles are being replaced with layers of the hydrophilic solutions. The result is an increase in specific weight of the sediment particles which at the same time leads to agglomeration. Therefore, the oil based lubricant separates even more easily from the sediments in the drilling oil mud.

It also has been found that the inventive liquid even can be applied to the effluent of stage b1) and, therefore, eliminating the necessity to use a second Decanter.

A most efficient separation takes place if the drilling mud is being vigorously mixed with the inventive solution at temperatures of up to 60° C. and is exposed to high gravitational forces. Various kinds of centrifuges can be employed. For example, clarifying liquid-liquid disc centrifuges with adjustable solids discharge mechanisms can be used. Another system working efficiently uses three stage Decanters, which are known in the industry as TriCanters, in which solid-liquid separation takes place, while simultaneously heavy and light liquid phases are being separated as well. Machines with a centripetal pump system allow a clean separation of the drilling oil lubricant from oil mud. Centrifuges can be operated either semi-continuous or completely continuous.

Another advantage of this invention is the fact that most inventive hydrophilic solutions are environmentally friendly and do not create any health hazards. Besides water, the preferred hydrophilic liquids are either food ingredients or are considered GRAS (Generally Recognized As Safe) by the Food and Drug Administration, because both glycerin and propylene glycol are allowed as food ingredients. [See 21CFR §152.1320(b) for glycerin and 21CFR §184.1666 for propylene glycol].

Description of Hydrophilic Separation Liquids:

Hydrophilic separation liquids with different specific densities are prepared as follows:

Separation Liquid A
800 lb water
200 lb glycerin
1,000 lb liquid; specific density: 1.047 (20° C.)

Separation Liquid B
550 lb water
100 lb glycerin
350 lb propylene glycol
1,000 lb liquid; specific density: 1.046 (20° C.)

Separation Liquid C
300 lb water
700 lb propylene glycol
1,000 lb liquid; specific density: 1.042 (20° C.)

Separation Liquid D
700 lb water
300 lb ethylene glycol
1,000 lb liquid; specific density: 1.050 (20° C.)

Separation Liquid E
400 lb water
250 lb glycerin
350 lb propylene glycol
1,000 lb liquid, specific density: 1.086 (20° C.)

Separation Liquid F:
350 lb water
300 lb propylene glycol
350 lb glycerin
1,000 lb liquid, specific density: 1.104 (20° C.)

Separation Liquid G:
198 lb water
388 lb propylene glycol
414 lb glycerin
1,000 lb liquid, specific density: 1.141 (20° C.)

Separation Liquid H:
460 lb propylene glycol
540 lb glycerin
1,000 lb liquid, specific density: 1.150 (20° C.)

Separation Liquid I:
150.0 lb water
350.0 lb propylene glycol
500.0 lb high fructose corn syrup (76° Brix)
1,000 lb liquid, specific density: 1.189 (20° C.)

Separation Liquid J:
120.0 lb water
280.0 lb propylene glycol
600.0 lb high fructose corn syrup (76° Brix)
1,000.0 lb liquid, specific density: 1.226

### Preparation Instructions:

Each of the separation liquids is prepared in a jacketed and/or insulated mixing tank (e.g., mixing tank 21) which is equipped with a high-speed mixer. While the ingredients are being mixed heat may be applied to the tank in order to increase the speed to reach a homogeneous mix. A sample is taken to determine the specific density of the liquid (at 20° C.).

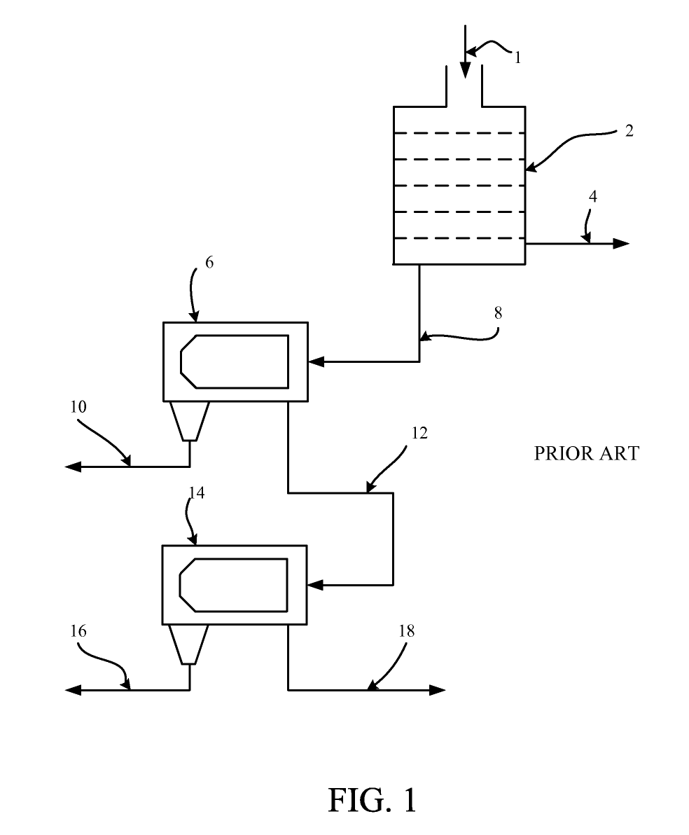

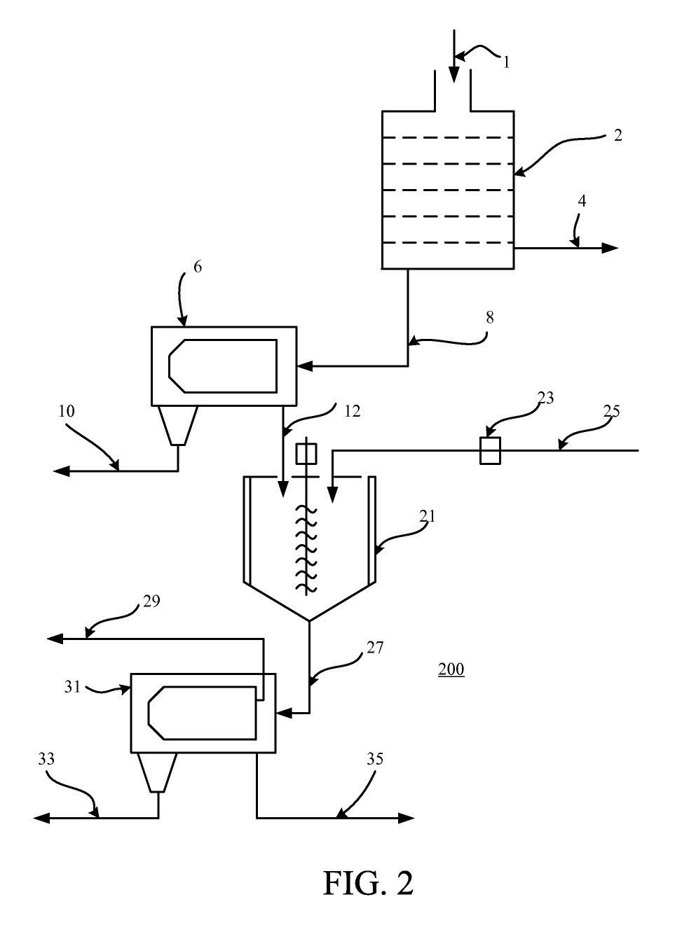

FIG. 2 shows the process of the invention as employed with at least one embodiment of a system of the invention for using same. Like numbers indicate like elements, so for any of the elements referred to in FIG. 1 above (e.g., the paths between elements 1, 4, 8, 10, 12, etc; the one or more vibrating sifters 2; the first decanter 6; etc.) also shown in FIG. 2 having the same reference number may function identically the same or in substantially the same manner. In addition to the one or more vibrating sifters 2, the first decanter 6 (and/or the second decanter as discussed below) and the various output and input paths to/from those elements (e.g., paths 1, 4, 8, 10, 12, etc.), the system 200 may further comprise a mixing tank 21 for receiving the first effluent from the first decanter 6 through connection 12 therebetween and for receiving a hydrophilic liquid or solution (e.g., any of any one or more of separation liquids A through J discussed above) therein from input 25. The mixing tank 21 operates to mix the hydrophilic liquid or solution with the first effluent. The input path 25 may run through a heat exchanger 23 so that the hydrophilic liquid or solution is about 140° F. before insertion into the mixing tank 21. The mixing of the hydrophilic liquid or solution with the first effluent including the oil lubricant and the one or more solid or fine materials having a predetermined size causes the one or more solid or fine materials having the predetermined size to bind to the hydrophilic liquid or solution. As such, those solid or fine materials become hydrophilic and separate from the one or more oil lubricants, which may be naturally hydrophobic, in the effluent. The mixture may then be sent to a tricanter 31 that operates to: (i) discharge any separated solids or fines (including e.g., fibrous materials or solids, crystalline materials or solids, low gravity solids, low gravity fines, etc.) through output 33 (e.g., to a storage bin, a container, a waste disposal system, etc.); and (ii) recover the hydrophilic liquid or solution and the clarified oil lubricant. The tricanter 31 may operate to send the recovered hydrophilic liquid or solution through output 29 to be recycled back into the mixing tank 21 (e.g., by connecting line 29 to line 25 such that the recovered hydrophilic liquid or solution may be disposed in line 25), and the tricanter 31 may operate to send the clarified oil lubricant through output 35 back to the well for use as a lubricant on the drilling machinery, such as the drilling bit. Alternatively, the mixing tank 21 may be connected to the second decanter 14 as described above such that it receives the further decanted effluent (also referred to as the second effluent) therein for processing as described above. Additionally, the output lines 4 and 10 may also lead to a respective storage bin, container, waste disposal system, etc. for appropriate processing of the discharged materials. The system 200 may be employed with the following examples described below.

### Preparation of Drilling Oil Mud for Separation:

### Example 1

Drilling oil mud, which flows out of the Decanter 2 [see stage b2) as described before], has an average temperature of about 100° F. to 120° F. It is pumped into an insulated mixing tank (e.g., mixing tank 21), which is equipped with a high-speed mixer and then is mixed with the inventive Separation Liquid C in the following proportion:
3,000 lb oil mud
1,000 lb Liquid C
4,000 lb

Liquid C is being heated to about 60° C. (about 140° F.) in a heat exchanger (e.g., heat exchanger 23) before entering the mixing tank (e.g., mixing tank 21).

Liquid C and oil mud, which has an average weight of 10.5 pound per gallon, are vigorously mixed to a uniform blend and charged into a Tricanter (e.g., tricanter 31) and separated at about 3,000 rpm. Almost all sediment solids, including fine solids, are discharged from the Tricanter (e.g., tricanter 31) at the opposite side of the liquid entry. The heavy-phase Liquid C is discharged under pressure (e.g., through output 29 of the tricanter 31) by adjusting the centripetal pump in such a way that the light-phase oil lubricant discharges clean by gravity flow. Before the clarified lubricant oil (light phase) is being recycled to the drilling bit, a sample is taken and analyzed for clarity and amount of any residual solids. The heavy-phase liquid may be reused again as separation liquid or may be discarded.

Table 2 shows the analytical data of the clarified oil lubricant as a result of the process.

TABLE 2
TriCanter Effluent/Clarified Oil Lubricant using
Drilling Oil Mud 2 from C) and Separation Liquid C

| | |
|---|---|
| 1. Flow in temperature TriCanter ° F. | 110-130 |
| 2. Flow out temperature TriCanter ° F. | 100-110 |
| 3. Oil Mud weight into mixing tank ppg | 9.5 |
| 4. Oil Mud density into mixing tank g/ccm | 1.138 |
| 5. Clarified Oil weight out ppg | 7.39 |
| 6. Clarified Oil density out g/ccm | 0.886 |
| 7. Oil content % by volume | |

The efficiency of the inventive process is clearly demonstrated. In this example the effluent after the high speed Decanter-2 was clarified by the inventive process using Separation Liquid C. The oil mud weight was reduced from 9.5 ppg to 7.39 ppg. The density of the clarified oil was measured as 0.886 g/ccm, which is well within the density range for diesel oil. Additionally or alternatively, spectrum size of the solids may be depicted via one or more graphs.

In order to establish that the inventive process also works when applied to the effluent of Decanter-1 (after the barite recovery), another test was performed.

### Example 2

Drilling oil mud which flows out of the Decanter 1 [see stage b1) as described before] has an average temperature of about 120° F.=49.9° C. and which has an average weight of 10.9 pound per gallon. It is pumped into an insulated mixing tank (e.g., mixing tank 21), which is equipped with a high-speed mixer and then is mixed with the inventive Separation Liquid F in the following proportion:
2,800 lb oil mud
1,200 lb Liquid F
4,000 lb

Liquid F is being heated to about 60° C. (about 140° F.) in a heat exchanger (e.g., heat exchanger 23) before entering the mixing tank (e.g., mixing tank 21). Liquid F and oil mud are vigorously mixed to a uniform blend and charged into a Tricanter (e.g., tricanter 31) and separated at about 3,500 rpm. A thick sludge of sediment solids is discharged from the three stage decanter at the opposite side of the liquid entry. The heavy-phase Liquid F is discharged under pressure (e.g., through output 29) by adjusting the centripetal pump in such a way that the light-phase oil lubricant discharges clean by gravity flow. Before the clarified lubricant oil (light phase) is being recycled to the drilling bit, a sample is taken and analyzed for clarity and amount of any residual solids. The heavy-phase liquid may be reused again as separation liquid or may be discarded.

Table 3 shows the analytical data of the clarified oil lubricant as a result of the process.

TABLE 3
TriCanter Effluent/Clarified Oil Lubricant using
Drilling Oil Mud 1 from D) and Separation Liquid F

| | |
|---|---|
| 1. Flow in temperature TriCanter ° F. | 110-130 |
| 2. Flow out temperature TriCanter ° F. | 100-110 |
| 3. Oil Mud weight in ppg | 10.5 |
| 4. Oil Mud density into tank g/ccm | 1.258 |
| 5. Clarified Oil weight out ppg | 7.15 |
| 6. Clarified Oil density out g/ccm | 0.853 |
| 7. Oil content % by volume | |

The inventive process clearly demonstrates that no second decanter (Decanter-2) is needed for clarifying the barite recovery effluent. Instead, this effluent is immediately mixed with the inventive liquid and separated in the TriCanter (e.g., tricanter 31). Oil Mud weight is reduced from 10.5 to 7.15 ppg. The density of the clarified oil was measured as 0.853 g/ccm, which is well within the density range for diesel oil. Therefore, the method(s) and system(s) of the present invention provide a critical and non-obvious improvement over the aforementioned prior art. Additionally or alternatively, spectrum size of the solids may be depicted via one or more graphs.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. A process for clarifying drilling mud and recovering one or more oil lubricants for recycling to a well to lubricate one or more drilling components, comprising:
mixing a hydrophilic liquid or solution with an effluent including an oil lubricant and one or more solid and/or fine materials having a predetermined size such that the one or more solid and/or fine materials having the predetermined size bind to the hydrophilic liquid or solution, thereby being hydrophilic and separating from, and clarifying, the one or more oil lubricants in the effluent; and
recovering the separated, clarified one or more oil lubricants.

2. The process of claim 1, wherein the one or more oil lubricants are hydrophobic, thereby promoting or facilitating the separation from at least one of the one or more hydrophilic solid and/or fine materials and the hydrophilic liquid or solution.

3. The process of claim 1, further comprising at least one of:
(i) recycling the clarified one or more oil lubricants to the well such that the clarified one or more oil lubricants lubricate the one or more drilling components located in the well;
(ii) discharging any of the one or more separated solid and/or fine materials; and
(iii) recovering the hydrophilic liquid or solution.

4. The process of claim 3, further comprising repeating the mixing and recovering of the separated, clarified one or more oil lubricants steps with the recovered hydrophilic liquid or solution.

5. The process of claim 3, further comprising supplying the mixture to one or more centrifuges or tricanters that operate to at least one of: (i) perform the recycling, discharging and recovering of the hydrophilic liquid or solution steps; (ii) separate the mixture at about 2,000 to about 3,000 rotations per minute; and (iii) discharge the hydrophilic liquid or solution under pressure via an adjustment of a centripetal pump such that the oil lubricant discharges cleanly by gravity flow for the recycling thereof.

6. The process of claim 1, wherein at least one of:
(i) the one or more solid and/or fine materials include at least one of fibrous materials or solids, crystalline materials or solids, low gravity solids and low gravity fines;
(ii) the mixing occurs in a mixing tank;
(iii) the mixing step further comprises creating a mixture of the oil mud or the effluent and the hydrophilic liquid or solution comprising about 25 percent of the hydrophilic liquid and about 75 percent of the oil mud or the effluent;
(iv) the mixing step further comprises creating a mixture of the oil mud or the effluent and the hydrophilic liquid or solution comprising about 30 percent of the hydrophilic liquid and about 70 percent of the oil mud or the effluent;
(v) the mixing step further comprises creating a mixture of the oil mud or the effluent and the hydrophilic liquid or solution comprising about 25 percent to about 30 percent of the hydrophilic liquid and about 70 percent to about 75 percent of the oil mud or the effluent;
(vi) the effluent is created by either a first decanter that operates to receive the drilling mud from the well and to remove one or more solid and/or fine materials, which are heavier than, or are larger than the predetermined size of, the one or more solid and/or fine materials having the predetermined size, and/or barite or a second decanter that receives an effluent from the first decanter and operates to remove additional one or more solid and/or fine materials, which are heavier than, or are larger than the predetermined size of, the one or more solid and/or fine materials having the predetermined size, and/or barite;
(vii) the hydrophilic liquid or solution is supplied to the effluent of the first decanter, thereby eliminating the need to use the second decanter;
(viii) the first decanter operates to receive the drilling mud indirectly from the well through one or more vibrating sifters;
(ix) the drilling mud flows from the well at a temperature of about 120° F.-about 140° F. and/or at a rate of about 200-about 250 gallons per minute;
(x) the one or more vibrating sifters operate to receive the drilling mud from the well and to remove debris from the drilling mud that is larger or heavier than the one or more solid and/or fine materials having the predetermined size;
(xi) the drilling mud is mixed with the hydrophilic liquid or solution at one or more temperatures of up to 60° C. and is exposed to high gravitational forces; and
(xii) the predetermined size is about 5 microns.

7. The process of claim 1, further comprising at least one of:
(i) heating the hydrophilic liquid or solution to about 140° F. before the mixing step;
(ii) mixing and heating a homogeneous mix defining the hydrophilic liquid or solution in a jacketed and/or insulated mixing tank, thereby increasing the speed to reach the homogeneous mix and the hydrophilic liquid or solution; and
(iii) applying one or more elevated temperatures such that a difference in a specific weight of the hydrophilic solution or liquid and a specific weight of the oil lubricant is created; and a difference in surface tension around any given particle of the one or more solid and/or fine materials is reached, thereby promoting separation of the oil lubricant from the one or more solid and/or fine materials.

8. A system for clarifying drilling mud and recovering one or more oil lubricants for recycling to a well to lubricate one or more drilling components, comprising:
a mixing tank that operates to: (i) receive a hydrophilic liquid or solution and an effluent including an oil lubricant and one or more solid and/or fine materials having a predetermined size therein; and (ii) mix the hydrophilic liquid or solution with the one or more solid and/or fine materials having the predetermined size such that the hydrophilic liquid or solution binds to the one or more solid and/or fine materials and the one or more bound solid and/or fine materials are hydrophilic; and
one or more centrifuges that operate to: (i) receive, from the mixing tank, the combination of the hydrophilic liquid or solution and effluent including the oil lubricant and the one or more solid or fine materials having the predetermined size; (ii) separate the hydrophilic liquid or solution, the one or more hydrophilic solid and/or fine materials and the oil lubricant from each other; and (iii) recycle the separated or clarified oil lubricant to the well for reuse as a lubricant for the one or more drilling components.

9. The system of claim 8, wherein at least one of:
(i) the one or more centrifuges include at least one of: a clarifying liquid to liquid disc centrifuge with one or more adjustable solids discharge mechanisms, one or more semi-continuous centrifuges, one or more continuous centrifuges, and a three stage decanter or tricanter;
(ii) the predetermined size is about 5 microns;
(iii) the mixing tank operates to create a mixture of the oil mud or the effluent and the hydrophilic liquid or solution, the mixture comprising at least one of: about 25 percent of the hydrophilic liquid and about 75 percent of the oil mud or the effluent, about 30 percent of the hydrophilic liquid and about 70 percent of the oil mud or the effluent, and about 25 percent to about 30 percent of the hydrophilic liquid and about 70 percent to about 75 percent of the oil mud or the effluent; and
(iv) the one or more centrifuges further operate to at least one of:
recover the hydrophilic liquid or solution and recycle the recovered hydrophilic liquid or solution to the mixing tank for reuse;
discharge any separated solid and/or fine materials;
separate the mixture at at least one of: about 3,000 rotations per minute; about 2,000 to about 3,500 rotations per minute; about 3,500 rotations per minute; and
discharge the hydrophilic liquid or solution under pressure via an adjustment of a centripetal pump connected to the one or more centrifuges such that the oil lubricant discharges cleanly by gravity flow for the recycling thereof.

10. The system of claim 8, further comprising one or more decanters that operate to separate drilling mud into the effluent and one or more solid and/or fine materials that are heavier than, or larger than the predetermined size of, the one or more solid and/or fine materials of the effluent, wherein
the mixing tank further operates to receive the effluent from the one or more decanters before mixing the effluent with the hydrophilic liquid or solution.

11. The system of claim 10, wherein at least one of:
(i) the one or more decanters comprise a first decanter and a second decanter, and the effluent is created by either the first decanter that operates to receive the drilling mud from the well and to remove one or more solid and/or fine materials, which are heavier than, or are larger than the predetermined size of, the one or more solid and/or fine materials having the predetermined size, and/or barite, or the second decanter that receives an effluent from the first decanter and operates to remove additional one or more solid and/or fine materials, which are heavier than, or are larger than the predetermined size of, the one or more solid and/or fine materials having the predetermined size, and/or barite; and
(ii) the one or more decanters comprise only a first decanter, wherein the hydrophilic liquid or solution is supplied to the effluent of the first decanter, thereby eliminating the need to use a second decanter.

12. The system of claim 10, further comprising one or more vibrating sifters that operate to receive the drilling mud from the well, to remove at least a portion of debris from the drilling mud that is larger or heavier than the one or more solid and/or fine materials having the predetermined size and to pass the remaining drilling mud into the one or more decanters.

13. The system of claim 12, wherein at least one of:
(i) the one or more decanters comprise a first decanter and a second decanter, and the effluent is created by either the first decanter that operates to receive the remaining drilling mud from the one or more vibrating sifters and/or the drilling mud from the well and to remove one or more solid and/or fine materials, which are heavier than, or are larger than the predetermined size of, the one or more solid and/or fine materials having the predetermined size, and/or barite, or the second decanter that receives an effluent from the first decanter and operates to remove additional one or more solid and/or fine materials, which are heavier than, or are larger than the predetermined size of, the one or more solid and/or fine materials having the predetermined size, and/or barite; and
(ii) the one or more decanters comprise only a first decanter, the first decanter operating to receive the remaining drilling mud from the one or more vibrating sifters and/or the drilling mud from the well and to remove one or more solid and/or fine materials, which are heavier than, or are larger than the predetermined size of, the one or more solid and/or fine materials having the predetermined size, and/or barite, thereby creating the effluent, wherein the hydrophilic liquid or solution is supplied to the effluent of the first decanter, thereby eliminating the need to use a second decanter.

14. The system of claim 8, further comprising means for controlling a flow of the drilling mud from the well at a temperature of about 120° F.-about 140° F. and/or at a rate of about 200-about 250 gallons per minute.

15. The system of claim 8, further comprising at least one of:
(i) a heat exchanger or a means for heating the hydrophilic liquid or solution to about 140° F. before the hydrophilic liquid or solution is introduced into the mix tank; and
(ii) a jacketed and/or insulated mixing tank that operates to heat a homogeneous mix defining the hydrophilic liquid or solution, thereby increasing the speed to reach the homogeneous mix and the hydrophilic liquid or solution.

16. A hydrophilic liquid or solution for separating, or improving the separation of, drilling mud from one or more oil lubricants, comprising a homogeneous mix of one or more of the following: Water, Glycerin, Propylene Glycol (1,2-Propanediol) and other water soluble Glycols and Polyols comprising at least one of Ethylene Glycol, Xylitol, Sorbitol, Glucose Syrup, Fructose Syrup, polymerized Polyols, and one or more solutions of Glycerin, Propylene Glycol (1,2-Propanediol), water soluble Glycols, water soluble Polyols, Ethylene Glycol, Xylitol, Sorbitol, Glucose Syrup, Fructose Syrup, and polymerized Polyols in water.

17. The hydrophilic liquid or solution of claim 16, further comprising at least one of the following mixture combinations: (i) about 20 percent glycerin and about 80 percent water; (ii) about 55 percent water, about 10 percent glycerin and about 35 percent propylene glycol; (iii) about 30 percent water and about 70 percent propylene glycol; (iv) about 70 percent water and about 30 percent ethylene glycol; (v) about 40 percent water, about 25 percent glycerin and about 35 percent propylene glycol; (vi) about 35 percent water, about 30 percent propylene glycol and about 35 percent glycerin; (vii) about 19.8 percent water, about 38.8 percent propylene glycol and about 41.4 percent glycerin; (viii) about 46 percent propylene glycol and 54 percent glycerin; (ix) about 15 percent water, about 35 percent propylene glycol and about 50 percent high fructose corn syrup (76° Brix); and about 12 percent water, about 28 percent propylene glycol and about 60 percent high fructose corn syrup (76° Brix).

18. The hydrophilic liquid or solution of claim 16, wherein the homogeneous mix is prepared in a jacketed and/or insulated mixing tank that operates to heat the mix, thereby increasing the speed to reach the homogeneous mix.

19. The hydrophilic liquid or solution of claim 16, having a specific density, at about 20° C., of: at least about 1.0 gram per cubic centimeter (“g/ccm”), about 1.047 g/ccm, about 1.046 g/ccm, about 1.042 g/ccm, about 1.050 g/ccm, about 1.086 g/ccm, about 1.104 g/ccm, about 1.141 g/ccm, about 1.150 g/ccm, about 1.189 g/ccm, about 1.226 g/ccm, about 1.042 g/ccm-about 1.226 g/ccm, greater than about 1.226 g/ccm.

20. The hydrophilic liquid or solution of claim 16, further comprising at least one of the following mixture combinations: (i) about 20 percent glycerin and about 80 percent water and having a specific density, at about at about 20° C., of about 1.047 g/ccm; (ii) about 55 percent water, about 10 percent glycerin and about 35 percent propylene glycol and having a specific density, at about at about 20° C., of about 1.046 g/ccm; (iii) about 30 percent water and about 70 percent propylene glycol and having a specific density, at about at about 20° C., of about 1.042 g/ccm; (iv) about 70 percent water and about 30 percent ethylene glycol and having a specific density, at about at about 20° C., of about 1.050 g/ccm; (v) about 40 percent water, about 25 percent glycerin and about 35 percent propylene glycol and having a specific density, at about at about 20° C., of about 1.086 g/ccm; (vi) about 35 percent water, about 30 percent propylene glycol and about 35 percent glycerin and having a specific density, at about at about 20° C., of about 1.104 g/ccm; (vii) about 19.8 percent water, about 38.8 percent propylene glycol and about 41.4 percent glycerin and having a specific density, at about at about 20° C., of about 1.141 g/ccm; (viii) about 46 percent propylene glycol and 54 percent glycerin and having a specific density, at about at about 20° C., of about 1.150 g/ccm; (ix) about 15 percent water, about 35 percent propylene glycol and about 50 percent high fructose corn syrup (76° Brix) and having a specific density, at about at about 20° C., of about 1.189 g/ccm; and about 12 percent water, about 28 percent propylene glycol and about 60 percent high fructose corn syrup (76° Brix) and having a specific density, at about at about 20° C., of about 1.226 g/ccm.

21. The hydrophilic liquid or solution of claim 16, wherein the homogeneous mix includes at least a bi-valent molecular structure having at least one hydrophobic group on one side of the molecule and at least one hydrophilic group on the other end of the molecule such that the bi-valent molecular structure is disposed in, or forced in, a border layer between the hydrophilic liquid or solution and a hydrophobic oil lubricant of a drilling mud having the oil lubricant and one or more solid and/or fine materials therein and/or the effluent such that one or more layers of the hydrophobic oil lubricants around the solid and/or fine materials are replaced with one or more layers of the hydrophilic liquid or solution, thereby permitting the separation, or the improved separation, of the oil lubricant from the one or more solid and/or fine materials.

22. The hydrophilic liquid or solution of claim 21, wherein the bi-valent molecular structure comprises 1,2-propanediol having one hydrophobic methyl (—CH3) group on one side of the molecule and two hydrophilic hydroxyl (—OH) groups on the other end such that any propylene glycol is oriented in, or forced in, a border layer between the hydrophilic liquid or solution and the hydrophobic oil lubricant, thereby removing the oil lubricant from the hydrophilic oriented solid and/or fine materials and forming a continuous oil layer above the hydrophilic liquid or solution.
